(19) United States
(12) Patent Application Publication
(10) Pub. No.: US 2025/0152317 A1
(43) Pub. Date: May 15, 2025

(54) Electric Mouthpiece Toothbrush

(71) Applicant: Arnaldo R. Garcia, JR., Sterling Heights, MI (US)

(72) Inventor: Arnaldo R. Garcia, JR., Sterling Heights, MI (US)

(21) Appl. No.: 18/944,600

(22) Filed: Nov. 12, 2024

Related U.S. Application Data
(60) Provisional application No. 63/598,306, filed on Nov. 13, 2023.

(51) Int. Cl. A61C 17/22

(52) U.S. Cl. CPC A61C 17/228

(57) ABSTRACT

A mouthpiece toothbrush that includes a carrier, one or more brushes, and an actuator. The carrier is configured to be secured between upper teeth and lower teeth of a user. The one or more brushes are movably coupled to the carrier such that the one or more brushes contact the upper teeth, the lower teeth, or both. The actuator is configured to move the one or more brushes with respect to the carrier such that the one or more brushes move along the upper teeth, the lower teeth, or both.

### CROSS-REFERENCE TO RELATED APPLICATION

This application claims priority to and the benefit of U.S. Provisional Application No. 63/598,306, filed on Nov. 13, 2023, the entire disclosure of which is incorporated by reference herein.

### TECHNICAL FIELD

This disclosure relates to a cleaning device, and more particularly, to an electric mouthpiece toothbrush.

### BACKGROUND

A toothbrush is used by a person to brush their teeth to remove food remnants and dental plaque sticking on the teeth. Dental diseases may occur if such food remnants and dental plaque are not removed from the teeth, thereby causing a loss of teeth or other adverse effects to the person. The person brushing their teeth with the toothbrush may be unable to clearly see the food remnants and dental plaque on their teeth (e.g., a back side of the teeth) or may brush for an inadequate duration of time. As a result, the person may improperly and/or ineffectively clean their teeth.

### SUMMARY

In one aspect of the present disclosure, a mouthpiece toothbrush is disclosed. The mouthpiece toothbrush includes a carrier, one or more brushes, and an actuator. The carrier is configured to be secured between upper teeth and lower teeth of a user. The one or more brushes are movably coupled to the carrier such that the one or more brushes contact the upper teeth, the lower teeth, or both. The actuator is configured to move the one or more brushes with respect to the carrier such that the one or more brushes move along the upper teeth, the lower teeth, or both.

Another aspect of the present disclosure is a mouthpiece toothbrush that includes a carrier, a brush plate movably coupled to the carrier, one or more brushes coupled to the carrier, and an actuator coupled to the brush plate. The carrier is configured to be secured between teeth of a user. Additionally, the actuator is configured to move the brush plate with respect to the carrier such that the one or more brushes move with respect to the teeth to clean the teeth.

Another aspect of the present disclosure is a mouthpiece toothbrush that includes a carrier, a brush plate movably coupled to the carrier, an upper brush coupled to the brush plate, a lower brush coupled to the brush plate, and an actuator. The carrier is configured to be secured between upper teeth and lower teeth of a user. The brush plate and the carrier define an upper channel and a lower channel. The upper brush is disposed in the upper channel and the lower brush is disposed in the lower channel. Additionally, the actuator is configured to move the brush plate with respect to the carrier to move the upper brush with respect to the upper teeth and to move the lower brush with respect to the lower teeth.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a perspective view of a mouthpiece toothbrush.

FIG. 2 is cross-section 2-2 of the mouthpiece toothbrush of FIG. 1.

FIG. 3 is cross-section 3-3 of the mouthpiece toothbrush of FIG. 1.

FIG. 4 is a cross-sectional view of a second example of a mouthpiece toothbrush.

FIG. 5 is a perspective view of a third example of a mouthpiece toothbrush.

FIG. 6 is a rear view of the mouthpiece toothbrush of FIG. 5.

FIG. 7 is a top-down view of a fourth example of a mouthpiece toothbrush.

### DETAILED DESCRIPTION

The present disclosure relates to a mouthpiece toothbrush used to clean teeth. In particular, the mouthpiece toothbrush may be a cleaning device, that includes one or more brushes that are configured to clean a user's teeth. As such, the mouthpiece toothbrush may be considered an alternative to a conventional toothbrush. By way of example, the mouthpiece toothbrush may be motorized and may be placed in the user's mouth, whereby the mouthpiece toothbrush may actuate one or more brushes to brush the user's teeth.

Conventional toothbrushes may require the user to manually clean each tooth. The brush portion of a toothbrush may include one or more bristles such that the user may manually move the toothbrush (e.g., via a handle) along their teeth to release food remnants and dental plaque sticking on the teeth. Due to the manual nature of the toothbrush, the user may often inadequately brush their teeth. For example, the user may brush for too short a duration of time to effectively release the food remnants and dental plaque sticking on the teeth. Similarly, the user may miss one or more teeth during brushing or may brush their teeth with an inadequate amount of pressure. As a result, the food remnants and dental plaque may remain on the user's teeth and eventually cause dental disease.

The present teachings provide a mouthpiece toothbrush that addresses the aforementioned challenges. The mouthpiece toothbrush herein may be configured to automatically clean the user's teeth and effectively remove the food remnants and dental plaque sticking on the user's teeth. Additionally, the mouthpiece toothbrush may be actuated by one or more motors such that the user is not required to manually operate the mouthpiece toothbrush to clean their teeth. As such, the mouthpiece toothbrush may more effectively and efficiently clean the user's teeth compared to a conventional toothbrush.

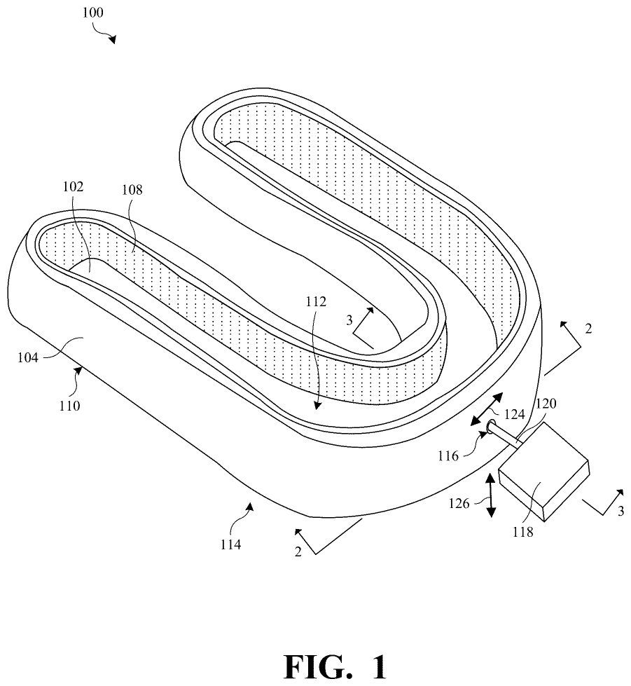

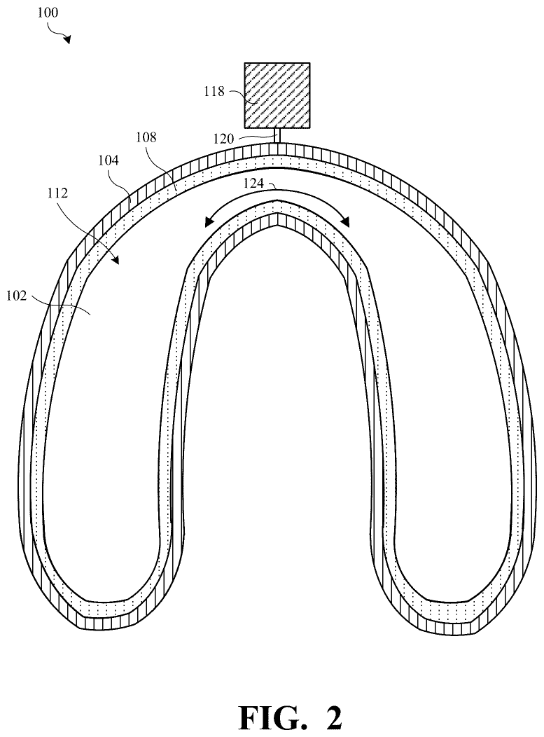

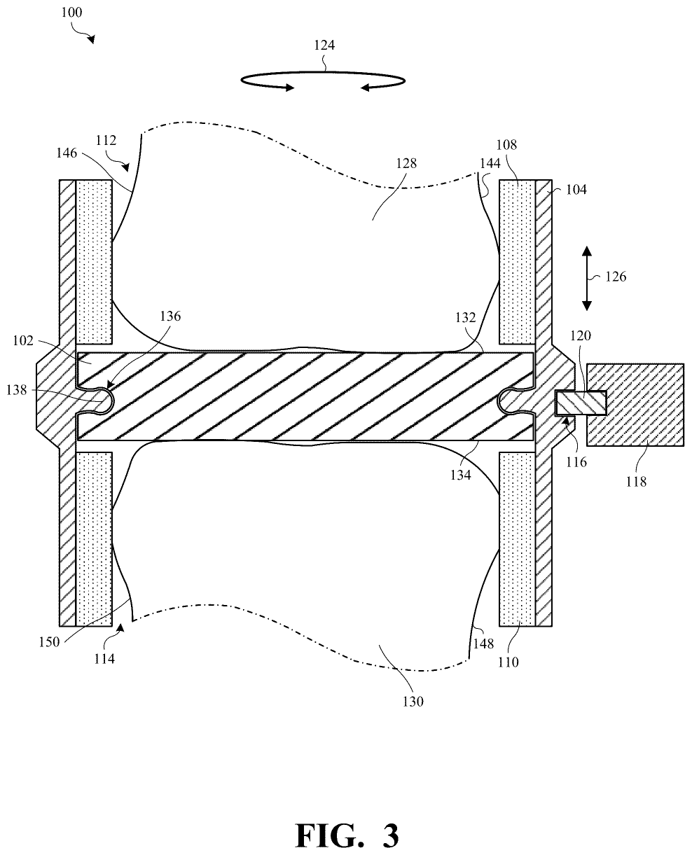

Turning now to the figures, FIG. 1 illustrates a perspective view of a mouthpiece toothbrush 100. FIG. 2 illustrates cross-section 2-2 of the mouthpiece toothbrush 100 shown in FIG. 1. Additionally, FIG. 3 illustrates cross-section 3-3 of the mouthpiece toothbrush 100 shown in FIG. 1.

As discussed above, the mouthpiece toothbrush 100 may be configured to fit into a user's mouth such that the mouthpiece toothbrush 100 at least partially surrounds the teeth of the user. For example, the mouthpiece toothbrush 100 may be generally shaped as a mouthguard or a retainer such that the mouthpiece toothbrush 100 may fit around the teeth of the user. As such, the mouthpiece toothbrush 100 may vary in size and/or shape to accommodate various teeth structures. For example, the mouthpiece toothbrush 100 may be scaled to accommodate an adolescent's mouth or the mouthpiece toothbrush 100 may be scaled to accommodate an adult's mouth.

The mouthpiece toothbrush 100 may include a carrier 102, which may be part of or form the mouthpiece of the mouthpiece toothbrush 100. As discussed in further detail below, the carrier 102 may be configured to be secured between teeth of the user to maintain a position of the mouthpiece toothbrush 100 during operation of the mouthpiece toothbrush 100. For example, the carrier 102 may include a curvature that generally follows a dental arch of the user (e.g., a curvature of the teeth of the user) such that the carrier 102 may be compressed between upper teeth 128 and lower teeth 130 of the user. Additionally, the carrier 102 may extend along a portion or an entirety of the dental arch of the user.

The carrier 102 may be made of any desired material. The carrier 102 may be formed from a compressible material, a rigid material, or both. For example, the carrier 102 may be made of ethylene vinyl acetate (EVA), polyurethane, polyethylene, polyvinyl acetate (PVA), silicone, or a combination thereof. Additionally, the carrier 102 may be made of a monolithic material or a composite material. For example, the carrier 102 may made from a composite material that includes one or more additives, whereby carrier 102 may exhibit anti-fungal and/or anti-microbial properties due to the one or more additives.

The mouthpiece toothbrush 100 may also include one or more brushes. The one or more brushes may be configured to contact the teeth of the user and move with respect to the teeth. That is, the one or more brushes may be configured to clean the teeth of the user. For example, the mouthpiece toothbrush 100 may include an upper brush 108 that is configured to contact the upper teeth 128 (i.e., an upper dental arch) of the user. However, the mouthpiece toothbrush 100 is not particularly limited to the upper brush 108. For example, as described in further detail below, the mouthpiece toothbrush 100 may also include a lower brush 110 that is configured to contact the lower teeth 130 (i.e., a lower dental arch) of the user. As such, the mouthpiece toothbrush 100 may clean all the teeth of the user simultaneously.

As shown in FIG. 1, the upper brush 108 may be configured to extend around the upper teeth 128 (i.e., the upper dental arch) such that the upper brush 108 may clean both a front surface 144 and a back surface 146 of the upper teeth 128. That is, the upper brush 108 may substantially surround the upper teeth 128 so that the upper teeth 128 are positioned between opposing portions of the upper brush 108. As a result, an entirety of the upper teeth 128 may be cleaned by the upper brush 108 during operation of the mouthpiece toothbrush 100. It should also be noted that the lower brush 110 of the mouthpiece toothbrush 100 may operate in a similar manner to clean an entirety of the lower teeth 130.

The one or more brushes (e.g., the upper brush 108 and the lower brush 110) are not limited to any particular structure. For example, the one or more brushes may include nylon bristles comparable to a conventional toothbrush, may include silicone bristles, or both. Alternatively, or additionally, the one or more brushes may include a textured surface that is configured to contact the teeth of the user. In any case, the one or more brushes may be configured to remove food remnants and dental plaque from the teeth. It should also be noted that the one or more brushes may facilitate cleaning of the teeth of the user with or without a cleaning substance, such as toothpaste.

The upper brush 108 and the lower brush 110 may be movably coupled to the carrier 102 such that the upper brush 108 contacts the upper teeth 128 of the user, the lower brush 110 contacts the lower teeth 130 of the user, or both. By way of example, the mouthpiece toothbrush 100 may include a brush plate 104. The upper brush 108 and the lower brush 110 may be coupled to the brush plate 104 and the brush plate 104 may be movably coupled to the carrier 102 such that the one or more brushes may also move with respect to the carrier 102. That is, the upper brush 108 and the lower brush 110 may be fixed to the brush plate 104 so that the upper brush 108, the lower brush 110, and the brush plate 104 may move with respect to the carrier 102. Thus, the carrier 102, the brush plate 104, the upper brush 108, the lower brush 110, or a combination thereof my form (e.g., define) the mouthpiece of the mouthpiece toothbrush 100.

The brush plate 104 may generally follow a contour of the upper brush 108 and/or a contour of the lower brush 110, or vice versa. For example, the brush plate 104 may extend around a perimeter of the dental arch of the user (e.g., the upper dental arch and/or the lower dental arch) to surround the upper teeth 128 and/or the lower teeth 130. The brush plate 104 and the carrier 102 may define an upper channel 112 that contains the upper brush 108 and a lower channel 114 that contains the lower brush 110. The upper channel 112 may be configured to receive the upper teeth 128 of the user and the lower channel 114 may be configured to receive the lower teeth 130 of the user.

As such, the brush plate 104 may provide a substrate and a support for the upper brush 108 and the lower brush 110. For example, the brush plate 104 may be structurally rigid compared to the upper brush 108 and/or the lower brush 110 to ensure contact of the upper brush 108 and the lower brush 110 with the teeth of the user during operation of the mouthpiece toothbrush 100.

As described above, the mouthpiece toothbrush 100 may be configured to clean the teeth of the user by moving the upper brush 108 and/or the lower brush 110 with respect to the teeth of the user. To facilitate such movement, the mouthpiece toothbrush 100 may include an actuator 118. The actuator 118 may be configured to move the one or more brushes (e.g., the upper brush 108 and/or the lower brush 110) with respect to the carrier 102 such that the one or more brushes move along the upper teeth, the lower teeth, or both of the user.

By way of example, the actuator 118 may be coupled to the brush plate 104 such that, when the actuator 118 articulates the brush plate 104, the upper brush 108 and the lower brush 110 may also articulate. The actuator 118 may include a movable member 120 that is drivable by the actuator 118 to articulate the brush plate 104 and the one or more brushes. The movable member 120 may be coupled to, or otherwise inserted into, an aperture 116 defined by the carrier 102. For example, the movable member 120 may extend into the aperture 116 and may be secured within the aperture 116. It should be noted that the movable member 120 may vary is structure based upon the type of actuator 118. For example, the movable member 120 may be a plunger, rod, gear, or other movable member.

The actuator 118 may articulate the brush plate 104, the upper brush 108, and the lower brush 110 in one or more directions. The actuator 118 may be configured to move the one or more brushes (e.g., the upper brush 108 and the lower brush 110) laterally with respect to the upper teeth and the lower teeth such that the one or more brushes may move laterally along the upper teeth, the lower teeth, or both. For example, the actuator 118 may move the upper brush 108 in the lateral direction 124 laterally along the upper teeth of the user to clean the upper teeth. Additionally, the actuator 118 may move the lower brush 110 in the lateral direction 124 laterally along the lower teeth of the user to clean the lower teeth.

Additionally, or alternatively, the actuator 118 may be configured to move the one or more brushes (e.g., the upper brush 108 and the lower brush 110) in an elevational direction 126 with respect to the upper teeth and the lower teeth of the user such that the one or more brushes may move upward and/or downward with respect to the upper teeth, the lower teeth, or both. While the actuator 118 may actuate the brush plate 104 and the one or more brushes in the lateral direction 124 and/or the elevational direction 126 as described above, the actuator 118 may also actuate the brush plate 104 and the one or more brushes in any desired direction. For example, the actuator 118 may actuate the brush plate 104 and the one or more brushes in a direction nonparallel to the elevational direction 126 and/or nonparallel to the lateral direction 124.

As stated above, FIG. 2 illustrates cross-section 2-2 of the mouthpiece toothbrush 100 shown in FIG. 1. The mouthpiece toothbrush 100 may include the carrier 102 that is configured to be disposed between teeth (e.g., upper teeth and lower teeth) of a user to maintain a position of the mouthpiece toothbrush 100 during operation of the mouthpiece toothbrush 100. Additionally, the mouthpiece toothbrush 100 may include the brush plate 104, whereby the brush plate 104 may be movably coupled to the carrier 102.

One or more brushes, such as the upper brush 108 and the lower brush 110, may be coupled to the brush plate 104 and generally form a perimeter around the upper teeth and/or the lower teeth of the user. As shown in FIG. 2, the carrier 102 may be generally contained or surrounded by the brush plate 104 and the upper brush 108. Moreover, the one or more brushes may be coupled to an interior surface of the brush plate 104 such that the one or more brushes may extend inward with respect to an exterior surface of the mouthpiece toothbrush 100 (the exterior surface of the brush plate 104 coupled to the actuator 118 by the movable member 120) towards the carrier 102. That is, the upper brush 108 may be contained within the upper channel 112 defined by the carrier 102 and the brush plate 104. Similarly, the lower brush 110 may be contained within the lower channel 114 defined by the carrier 102 and the brush plate 104.

Moreover, as described above, the actuator 118 may be coupled to the brush plate 104 by the movable member 120. As such, the actuator 118 may articulate the brush plate 104 and the one or more brushes (e.g., the upper brush 108 and the lower brush 110) in the lateral direction 124 and/or the elevational direction 126 with respect to the upper teeth and/or the lower teeth.

As stated above, FIG. 3 illustrates cross-section 3-3 of the mouthpiece toothbrush 100 shown in FIG. 1. The mouthpiece toothbrush 100 may include the carrier 102. The carrier may be configured to be secured between upper teeth 128 and lower teeth 130 of the user to maintain a position of the mouthpiece toothbrush 100 during operation of the mouthpiece toothbrush 100. That is, the user may bite down on the carrier 102 to clamp the carrier 102 between the upper teeth 128 and the lower teeth 130.

The mouthpiece toothbrush 100 may also include the brush plate 104. The brush plate may be movably coupled to the carrier 102. Additionally, the brush plate 104 and the carrier 102 may define one or more channels of the mouthpiece toothbrush 100. For example, the brush plate 104 may extend substantially perpendicular to the carrier 102 so that the brush plate 104 and the carrier 102 may define the upper channel 112 and the lower channel 114.

In particular, the brush plate 104 and an upper surface 132 of the carrier 102 may define the upper channel 112. Similarly, the brush plate 104 and a lower surface 134 of the carrier 102 that opposes the upper surface 132 may define the lower channel 114. As shown in FIG. 3, the upper channel 112 may be configured to receive the upper teeth 128 and the lower channel 114 may be configured to receive the lower teeth 130.

One or more brushes may be coupled to the brush plate 104, such as the upper brush 108 and the lower brush 110. As shown in FIG. 3, the upper brush 108 may be coupled to the brush plate 104 and disposed in the upper channel 112. Similarly, the lower brush 110 may be coupled to the brush plate 104 and disposed in the lower channel 114. Based on such a configuration, the upper brush 108 and the lower brush 110 may extend inward towards a central region of the upper channel 112 and the lower channel 114, respectively. Additionally, as shown in FIG. 3, the carrier 102 may be positioned between the upper brush 108 and the lower brush 110.

As described above, the upper brush 108 and the lower brush 110 may be configured to clean the teeth of the user. The upper brush 108 may be configured to contact a front surface 144 of the upper teeth 128 and a back surface 146 of the upper teeth 128. Similarly, the lower brush 110 may be configured to contact a front surface 148 of the lower teeth 130 and a back surface 150 of the lower teeth 130. As a result, the upper brush 108 may clean both the front surface 144 and the back surface 146 of the upper teeth 128 and the lower brush 110 may clean both the front surface 148 and the back surface 150 of the lower teeth 130 (e.g., via actuation of the upper brush 108 and the lower brush 110 by the actuator 118).

Additionally, the upper brush 108 may be configured to extend around the upper teeth 128 and the lower brush 110 may be configured to extend around the lower teeth 130. As a result, the upper brush 108 at substantially or entirely surround the upper teeth 128 and the lower brush 110 may substantially or entirely surround the lower teeth 130. Thus, the upper brush 108 and the lower brush 110 may ensure cleaning coverage of upper teeth 128 and the lower teeth 130, include regions of the teeth that may otherwise be difficult to clean with a conventional toothbrush (e.g., wisdom teeth or other molars located in the back of the mouth of the user).

The mouthpiece toothbrush 100 may include the actuator 118 coupled to the brush plate 104 and configured to move the brush plate 104 with respect to the carrier 102 such that the one or more brushes (e.g., the upper brush 108 and the lower brush 110) move with respect to the teeth (e.g., the upper teeth 128 and the lower teeth 130) to clean the teeth. That is, the actuator 118 may be coupled to the brush plate 104 and configured to move the brush plate 104 with respect to the carrier 102 to move the upper brush 108 with respect to the upper teeth 128 and to move the lower brush 110 with respect to the lower teeth 130. The brush plate 104, the upper brush 108, and the lower brush 110 may be actuated in the elevational direction 126 and/or the lateral direction 124 with respect to the teeth.

The actuator 118 may be powered by an internal power source and/or an external power source. For example, the actuator 118 may include one or more batteries disposed within the actuator 118 that may power the actuator 118. Additionally, or alternatively, the actuator 118 may be connected to an external power source (e.g., a wall outlet, external battery, computer, other electronic device, etc.) by a cord, whereby the external power source may power the actuator 118. It should also be noted that the external power source may charge an internal power source of the actuator 118, such as the one or more batteries discussed above.

The actuator 118 may be an electric motor (e.g., a DC motor, an AC motor, a stepped motor, etc.), a piezoelectric actuator, or a magnetic actuator. The actuator 118 may be configured to actuate the brush plate 104 in response to a signal from a controller or a switch, such as a controller or a switch of the mouthpiece toothbrush 100. For example, the actuator 118 may move the brush plate 104 with respect to the carrier 102 in the elevational direction 126 and/or the lateral direction 124 in response to a user commend provided through a user interface of the mouthpiece toothbrush 100 (e.g., a button, switch, etc.)

To facilitate such articulation, the actuator 118 may include or be coupled to the movable member 120, whereby the movable member 120 is coupled to the brush plate 104. By way of example, the actuator 118 may include a plunger or rod that is received by the aperture 116 of the brush plate 104. The actuator 118 may actuate the movable member 120, such as in the elevational direction 126 and/or the lateral direction 124 to move the brush plate 104 and the one or more brushes (e.g., the upper brush 108 and the lower brush 110).

The brush plate 104 may be movably coupled to the carrier 102 and move with respect to the carrier 102. That is, when the carrier 102 is secured between the upper teeth 128 and the lower teeth 130 of the user, the carrier 102 may remain stationary while the brush plate 104 moves with respect to the carrier 102 to clean the upper teeth 128 and the lower teeth. The brush plate 104 may be coupled to the carrier 102 using any desired structure that may allow the brush plate 104 to move with respect to the carrier 102. For example, the brush plate 104 and the carrier 102 may form a joint (e.g., dovetail joint, mortise and tenon joint, biscuit joint, etc.) therebetween. Alternatively, the brush plate 104 may be movably coupled to the carrier 102 by one or more hinges, one or more fasteners, or both.

By way of example, the brush plate 104 may include an engaging portion 138 and the carrier 102 may include a receiving portion 136. The receiving portion 136 of the carrier 102 may receive the engaging portion 138 of the brush plate 104 to movably couple the brush plate 104 to carrier 102. That is, the engaging portion 138 may be secured within the receiving portion 136 and move with respect to the receiving portion 136. For example, the actuator 118 may articulate the brush plate 104 in the lateral direction 124, whereby the engaging portion 138 of the brush plate 104 may move in the lateral direction 124 with respect to the receiving portion 136 of the carrier 102.

The engaging portion 138 of the brush plate 104 may be monolithically (i.e., integrally) formed with the brush plate 104 or may be a secondary component coupled to the brush plate 104. As such, the engaging portion 138 may exhibit similar or different material characteristics compared the brush plate 104. For example, the engaging portion 138 may be flexible such that the brush plate 104 may be configured to deflect in the elevational direction 126 with respect to the carrier 102. That is, the receiving portion 136 of the carrier 102 may allow lateral movement of the brush plate 104 in the lateral direction 124 yet may constrain movement of the brush plate 104 in the elevational direction 126. As such, the engaging portion 138 of the brush plate 104 may be flexible to facilitate deflection (e.g., flexing) of the brush plate 104 in the elevational direction 126 (e.g., up and down with respect to the upper teeth 128 and the lower teeth 130) based upon articulation by the actuator 118. As a result, the engaging portion 138 may provide additional movement of the brush plate 104, the upper brush 108, and the lower brush 110.

It should also be noted that the flexibility of the engaging portion 138 may allow for movement of the brush plate 104 with respect to the carrier 102 even when the brush plate 104 and/or the carrier 102 include a curvature. For example, as shown in FIGS. 1 and 2, the brush plate 104 may follow a contour of the carrier 102 to form a shape that may generally surround the upper teeth 128 and the lower teeth 130 (e.g., in the upper channel 112 and the lower channel 114, respectively). Due to the flexibility of the engaging portion 138 and/or the flexibility of the brush plate 104 in its entirety, the brush plate 104 may still move in the elevational direction 126 with respect to the carrier 102. As such, the receiving portion 136 of the carrier 102 may act as a track for the engaging portion 138 of the brush plate 104. Due to such curvature of the carrier 102 and the brush plate 104, the lateral direction 124 is illustrated as an arcuate arrow. However, in certain locations along the mouthpiece toothbrush 100, the lateral direction 124 may be linear. That is, the brush plate 104 may translate with respect to the carrier 102 in certain locations along the mouthpiece toothbrush 100.

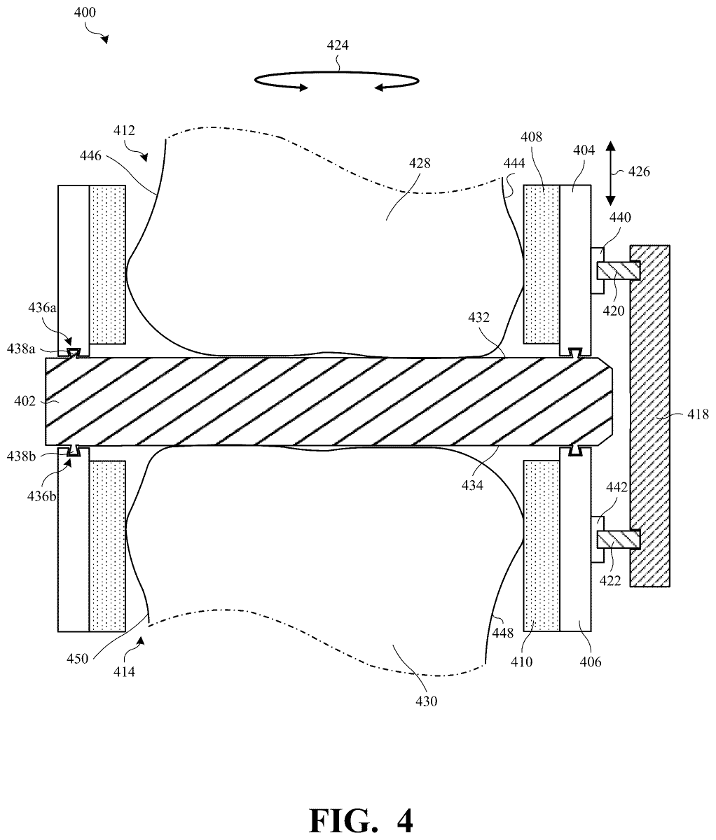

FIG. 4 illustrates a cross-sectional view of a second example of a mouthpiece toothbrush 400. The mouthpiece toothbrush 400 may be similar to the mouthpiece toothbrush 100 described above unless otherwise stated.

The mouthpiece toothbrush 400 may include a carrier 402 that may be similar to the carrier 102. That is, the carrier 402 may be secured between upper teeth 428 and lower teeth 430 of the user during operation of the mouthpiece toothbrush 400. The carrier 402 may also include an upper brush plate 404 and a lower brush plate 406. The upper brush plate 404 and the lower brush plate 406 may be movably coupled to the carrier 402 and configured to move with respect to the carrier 402.

By way of example, an upper engaging portion 438a of the carrier 402 may be inserted into a receiving portion 436a of the upper brush plate 404 to couple the upper brush plate 404 to the carrier 402. Similarly, the lower engaging portion 438b of the carrier 402 may be inserted into a receiving portion 436b of the lower brush plate 406 to couple the lower brush plate 406 to the carrier 402. The receiving portion 436a of the upper brush plate 404 may move with respect to the upper engaging portion 438a of the carrier 402 and the receiving portion 436b of the lower brush plate 406 may move with respect to the lower engaging portion 438b of the carrier. As such, the upper brush plate 404 and the lower brush plate 406 may move with respect to the carrier 402.

An upper surface 432 of the carrier 402 and the upper brush plate 404 may define an upper channel 412 of the mouthpiece toothbrush 400, whereby an upper brush 408 may be disposed in the upper channel 412 and coupled to the upper brush plate 404. Similarly, the carrier 402 and a lower surface 434 of the carrier 102 that opposes the upper surface 432 may define a lower channel 414 of the mouthpiece toothbrush 400, whereby a lower brush 410 may be disposed in the lower channel 414 and coupled to the lower brush plate 406.

To facilitate cleaning of the teeth, the upper teeth 428 may be positioned in the upper channel 412 so that the upper brush 408 may contact a front surface 444 and a back surface 446 of the upper teeth 428. Similarly, the lower teeth 430 may be positioned in the lower channel 414 so that the lower brush 410 may contact a front surface 448 and a back surface 450 of the lower teeth 430. The upper brush 408 and the lower brush 410 may move with respect to the upper teeth 428 and the lower teeth 430, respectively. The upper brush 408 and the lower brush 410 may move in a lateral direction 424 and/or an elevational direction 426 based upon actuation of the upper brush plate 404 and the lower brush plate 406, respectively.

The mouthpiece toothbrush 400 may include an actuator 418 to actuate the upper brush plate 404 and the lower brush plate 406. The actuator 418 may be similar to the actuator 118 described above. While the mouthpiece toothbrush 400 may include only a single actuator (e.g., the actuator 418), the mouthpiece toothbrush 400 may also include more than one actuator. For example, the mouthpiece toothbrush may include a first actuator that actuates the upper brush plate 404 and may also include a second actuator that actuates the lower brush plate 406.

As shown in FIG. 4, the actuator 418 may include a first movable member 420 and a second movable member 422. The first movable member 420 and the second movable member 422 may be actuated (e.g., articulated) by the actuator 418, such as in the lateral direction 424. By way of example the first movable member 420 and the second movable member 422 may each be a gear or a plurality of gears. The gear or the plurality of gears may be movably coupled (e.g., rotatably coupled) to the actuator 418 so that the actuator 418 may rotate the gear of the plurality of gears.

The first movable member 420 may engage upper gear teeth 440 located on the upper brush plate 404 to drive movement of the upper brush plate 404 in the lateral direction 424. Similarly, the second movable member 422 may engage lower gear teeth 442 located on the lower brush plate 406 to drive movement of the lower brush plate 406. The upper gear teeth 440 and the lower gear teeth 442 may be disposed annularly around the mouthpiece toothbrush 400 to facilitate movement of the upper brush plate 404 and the lower brush plate 406 with respect to the carrier 402.

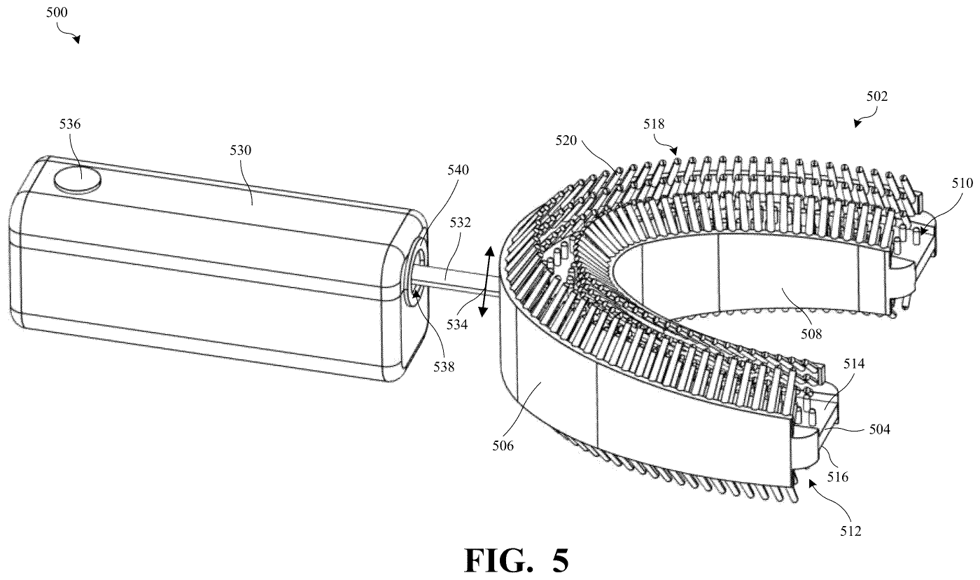

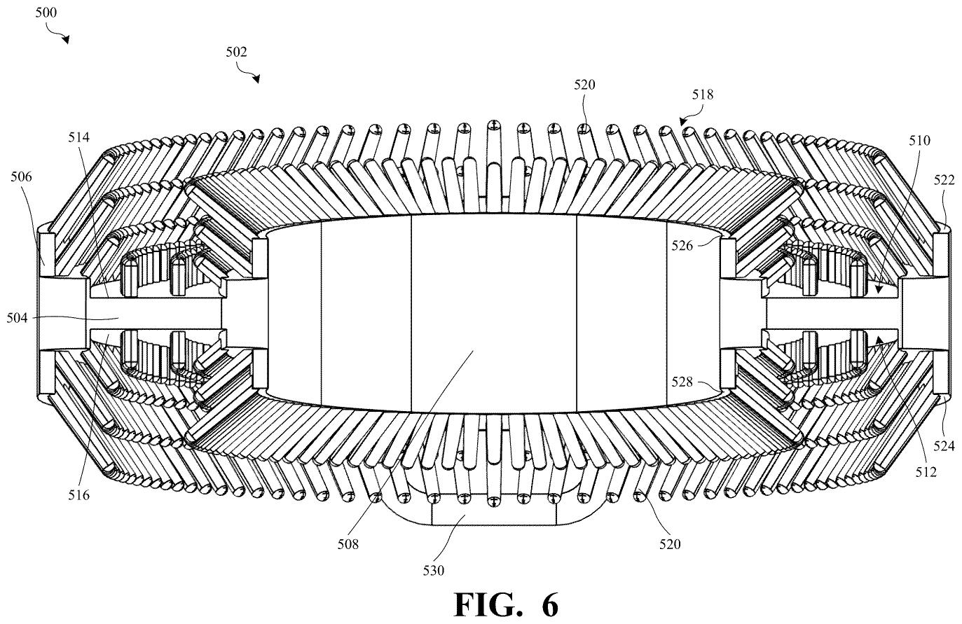

FIGS. 5 and 6 illustrate a perspective view and a rear view, respectively of a third example of a mouthpiece toothbrush 500. The mouthpiece toothbrush 500 may be similar to the mouthpiece toothbrush 100 shown in FIGS. 1-3 or the mouthpiece toothbrush 400 shown in FIG. 4.

The mouthpiece toothbrush 500 may include a mouthpiece 502 that is configured to be secured by the teeth of a user. In particular, the mouthpiece 502 may include a carrier 504 that may be similar to the carrier 102 of the mouthpiece toothbrush 100 or the carrier 402 of the mouthpiece toothbrush 400. For example, the carrier 504 may be secured between upper teeth (e.g., the upper teeth 128 of FIG. 3) and lower teeth (e.g., the lower teeth 130 of FIG. 3) of the user during operation of the mouthpiece toothbrush 500. The carrier 504 may be integrally (e.g., monolithically) formed or may include interconnected components (e.g., the carrier 504 and a brush plate similar to the brush plate 104 of FIGS. 1-3), whereby the interconnected components may be fixed to one another or may be movable relative to one another.

As shown in FIGS. 5 and 6, the carrier 504 may include or be connected to an outer wall 506 and an inner wall 508. The outer wall 506 and/or the inner wall 508 may extend substantially vertically such that the outer wall 506 and/or the inner wall 508 may extend substantially parallel to an outer surface and/or an inner surface of the teeth of the user. The outer wall 506 and/or the inner wall 508 may define a general curvature of the mouthpiece 502 that may follow a dental arch of the user (e.g., a curvature of the teeth of the user). Thus, in some configurations, the outer wall 506 and the inner wall 508 may be parallel to one another.

The carrier 504 may be disposed between the outer wall 506 and the inner wall 508. For example, as shown in FIGS. 5 and 6, the carrier 504 may extend substantially orthogonal to the outer wall 506 and/or the inner wall 508 such that the outer wall 506, the inner wall 508, and the carrier 504 may define an upper channel 510 and a lower channel 512 of the mouthpiece 502. The carrier 504 may also be positioned with any desired orientation with respect to the outer wall 506 and the inner wall 508 (e.g., other than substantially orthogonal to the outer wall 506 and the inner wall 508).

To secure the mouthpiece 502 within the user's mouth, the user may clamp down on the carrier 504 such that an upper surface 514 of the carrier 504 and a lower surface 516 of the carrier 504 may be clamped between the teeth (e.g., the upper teeth and the lower teeth) of the user to maintain a position of the mouthpiece 502 during operation. Based upon such positioning of the mouthpiece 502 within the user's mouth, a brush 518 of the mouthpiece 502 may contact the teeth (e.g., the upper teeth and/or the lower teeth) of the user. In particular, the brush 518 may include bristles 520 that project from the outer wall 506, the inner wall 508, the carrier 504, or a combination thereof. For example, as shown in FIGS. 5 and 6, the bristles 520 may be present generally throughout an entirety of the upper channel 510 and the lower channel 512. The bristles 520 may extend inwardly (e.g., towards the teeth of the user) from the upper surface 514 of the carrier 504, the lower surface 516 of the carrier 504, an inner surface of the outer wall 506 (e.g., an inner surface that at least partially defines the upper channel 510 and/or the lower channel 512), an inner surface of the inner wall 508 (e.g., an inner surface that at least partially defines the upper channel 510 and/or the lower channel 512), a top edge 522 of the outer wall 506, a bottom edge 524 of the outer wall 506, a top edge 526 of the inner wall 508, a bottom edge 528 of the inner wall 508, or a combination thereof. Thus, the bristles 520 may substantially encompass the teeth of the user to effectively clean the teeth of the user.

Once the mouthpiece 502 is properly positioned in the mouth of the user (e.g., to encompass the teeth of the user), the mouthpiece 502 may be actuated (e.g., vibrated, oscillated, translated, etc.) such that the bristles 520 may brush against the teeth of the user to clean the teeth. For example, as shown in FIG. 5, the mouthpiece toothbrush 500 may include an actuator 530 in movable communication with the mouthpiece 502. The actuator 530 may include or be coupled to a movable member 532 (e.g., a shaft, spindle, arm, etc.), whereby the movable member 532 may be coupled to the mouthpiece 502 to actuate (e.g., vibrate, oscillate, translate, etc.) the mouthpiece 502 in a direction 534. That is, the actuator 530 may actuate all or a portion of the mouthpiece 502, such as the brush 518 (e.g., the bristles 520), the outer wall 506, the inner wall 508, the carrier 504, or a combination thereof.

To initiate operation of the mouthpiece toothbrush 500, the user may secure the mouthpiece 502 in their mouth and activate (e.g., turn on) the actuator 530 via a user interface 536 (e.g., a button, switch, touchscreen, capacitive touch sensor, etc.) Activation of the actuator 530 may thus cause the movable member 532 to actuate, which may in turn actuate the mouthpiece 502. For example, the actuator 530 may be or may include a motor located within the confines of the actuator 530 (e.g., within the housing of the actuator 530). The movable member 532 may extend through an aperture 538 defined by the actuator 530 (e.g., defined by the housing of the actuator 530) and couple to the motor such that the motor may move the movable member 532 in the direction 534, thereby actuating the mouthpiece 502. The aperture 538 may also include a gasket 540 to prevent unwanted debris and/or moisture (e.g., water, toothpaste, etc.) from entering the actuator 530. Thus, the connection between the actuator 530 and the mouthpiece 502 may facilitate easy operation by the user to effectively clean their teeth.

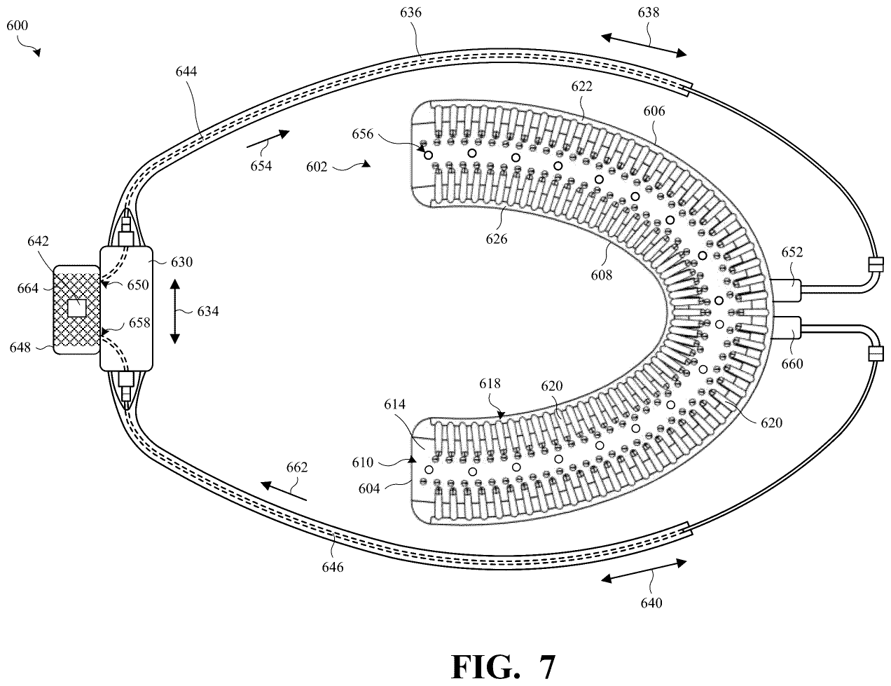

FIG. 7 illustrates a top-down view of a fourth example of a mouthpiece toothbrush 600. The mouthpiece toothbrush 600 may be similar to the mouthpiece toothbrush 100 shown in FIGS. 1-3, the mouthpiece toothbrush 400 shown in FIG. 4, and the mouthpiece toothbrush 500 shown in FIGS. 5 and 6.

The mouthpiece toothbrush 600 may include a mouthpiece 602 that is configured to be secured by the teeth of a user. In particular, the mouthpiece 602 may include a carrier 604 that may be similar to the carrier 102 of the mouthpiece toothbrush 100, the carrier 402 of the mouthpiece toothbrush 400, or the carrier 504 of the mouthpiece toothbrush 500. For example, the carrier 604 may be secured between upper teeth (e.g., the upper teeth 128 of FIG. 3) and lower teeth (e.g., the lower teeth 130 of FIG. 3) of the user during operation of the mouthpiece toothbrush 600. As discussed above, the carrier 604 may be integrally (e.g., monolithically) formed or may include interconnected components (e.g., the carrier 504 and a brush plate similar to the brush plate 104 of FIGS. 1-3), whereby the interconnected components may be fixed to one another or may be movable relative to one another.

As shown in FIG. 7, the carrier 604 may include or be connected to an outer wall 606 and an inner wall 608. The outer wall 606 and/or the inner wall 608 may extend substantially vertically such that the outer wall 506 and/or the inner wall 508 may extend substantially parallel to an outer surface and/or an inner surface of the teeth of the user, such as shown by the mouthpiece toothbrush 500 shown in FIGS. 5 and 6. As shown in FIG. 7, the outer wall 606 and/or the inner wall 608 may define a general curvature of the mouthpiece 602 that may follow a dental arch of the user (e.g., a curvature of the teeth of the user).

The carrier 604 may be disposed between the outer wall 606 and the inner wall 608. For example, as shown in FIG. 7, the carrier 604 may extend substantially orthogonal to the outer wall 606 and/or the inner wall 608 such that the outer wall 606, the inner wall 608, and the carrier 604 may define an upper channel 610 and a lower channel (e.g., a lower channel similar to the lower channel 512) of the mouthpiece 602. That is, the general size and/or shape of the mouthpiece 602 may be similar to or the same as the size and/or shape of the mouthpiece 502 shown in FIGS. 5 and 6 unless otherwise stated.

To secure the mouthpiece 602 within the user's mouth, the user may clamp down on the carrier 604 such that an upper surface 614 of the carrier 604 and a lower surface (e.g., a lower surface similar to the lower surface 516) of the carrier 604 may be clamped between the teeth (e.g., the upper teeth and the lower teeth) of the user to maintain a position of the mouthpiece 602 during operation. The mouthpiece toothbrush 600 may also include a strap 636, which may be secured around a head of the user to further maintain a position of the mouthpiece 602 during operation. The strap 636 may be any type of strap (e.g., a band, cord, etc.) that may be secured around the head of the user.

Based upon such positioning of the mouthpiece 602 within the user's mouth, a brush 618 of the mouthpiece 602 may contact the teeth (e.g., the upper teeth and/or the lower teeth) of the user. In particular, the brush 618 may include bristles 620 that project from the outer wall 606, the inner wall 608, the carrier 604, or a combination thereof. For example, the bristles 620 may be present generally throughout an entirety of the upper channel 610 and the lower channel. The bristles 620 may extend inwardly (e.g., towards the teeth of the user) from the upper surface 614 of the carrier 604, the lower surface of the carrier 604, an inner surface of the outer wall 606 (e.g., an inner surface that at least partially defines the upper channel 610 and/or the lower channel), an inner surface of the inner wall 608 (e.g., an inner surface that at least partially defines the upper channel 510 and/or the lower channel), a top edge 622 of the outer wall 506, a bottom edge of the outer wall 606 (e.g., a bottom edge similar to the bottom edge 524 of the outer wall 506), a top edge 626 of the inner wall 608, a bottom edge of the inner wall 608 (e.g., a bottom edge similar to the bottom edge 528 of the inner wall 508), or a combination thereof. Thus, the bristles 620 may substantially encompass the teeth of the user to effectively clean the teeth of the user.

Once the mouthpiece 602 is properly positioned in the mouth of the user (e.g., to encompass the teeth of the user), the mouthpiece 602 may be actuated (e.g., vibrated, oscillated, translated, etc.) such that the bristles 620 may brush against the teeth of the user to clean the teeth. For example, as shown in FIG. 6, the mouthpiece toothbrush 600 may include an actuator 630 in movable communication with the mouthpiece 602. The actuator 630 may be configured to actuate in a direction 634 to actuate (e.g., vibrate, oscillate, translate, etc.) the mouthpiece 602. In particular, the actuator 630 may actuate in the direction 634 to actuate the strap 636 in the direction 638 on a first side of the user's head (e.g., a left side or a right side) and in the direction 640 on an opposing second side of the user's head (e.g., an opposing left side or right side) to thereby actuate (e.g., vibrate, oscillate, translate, etc.) the mouthpiece 602.

The mouthpiece toothbrush 600 may also include a recirculating fluid system, which may be configured to circulate fluid through the mouthpiece 602 to better clean the teeth of the user. That is, the recirculating fluid system may cycle fluid (e.g., water, saline, mouthwash, etc.) through the mouthpiece so that the fluid may be applied to the teeth of the user, whereby the recirculating fluid system may also return any used fluid (e.g., applied fluid) back through the recirculating fluid system to preserve a volume of the fluid within the recirculating fluid system. That is, the recirculating fluid system may be a closed loop or semi-closed loop system that contains the fluid.

To operate the recirculating fluid system, the mouthpiece toothbrush 600 may include a pump 642, a supply line 644, and a return line 646. The pump 642 may be configured to cycle (e.g., pump) the fluid through the supply lines 644 and through the mouthpiece 602 so that the fluid may contact and cleanse the teeth of the user. The pump 642 may be further configured to return the fluid from the mouthpiece 602 through the return line 646 after the fluid cleanses the teeth of the user or is otherwise dispersed through the mouthpiece 602.

To illustrate such operation, as shown in FIG. 7, the supply line 644 may connect the pump 642 to the mouthpiece 602. For example, the pump 642 may be positioned in, coupled to, or otherwise in communication with a reservoir 648 that defines a cavity therein to store the fluid. In particular, the supply line 644 may be connected to the reservoir 648 and/or the pump 642 via an outlet 650. The supply line 644 may be further coupled to the mouthpiece 602 via a supply line connector 652 (e.g., an inlet of the mouthpiece 602). As such, fluid communication may be established between the pump 642 and the mouthpiece 602 via the supply line 644 such that the fluid may travel in a supply flow direction 654 from the reservoir 648 to the mouthpiece 602.

Once the fluid reaches the mouthpiece 602, the fluid may be dispersed through one or more openings 656 defined by the mouthpiece 602 to reach the teeth of the user. For example, the one or more openings 656 may be located on the carrier 604 (e.g., the upper surface 614 of the carrier 604 and/or the lower surface of the carrier), on the outer wall 606, on the inner wall 608, or a combination thereof. The openings 656 are not particularly limited in size, shape, or number. Thus, any number of the openings 656 may be present on the mouthpiece 602 to facilitate flow of the fluid to the teeth.

Once the fluid cleanses the teeth, the fluid (e.g., the used fluid) may be returned to the reservoir 648 via the return line 646. For example, a first portion of the openings 656 may provide outlets for the fluid to exit the mouthpiece 602 and reach the teeth of the user while a second portion of the openings 656 may provide inlets for the fluid reenter the mouthpiece 602 and reach the return line 646 to return to the reservoir 648. However, any openings or other suction-type mechanism may be integrated into the mouthpiece 602 to facilitate capturing of the fluid once dispersed.

Similar to the supply line 644, the return line 646 may connect the reservoir 648 and thus the pump 642 to the mouthpiece 602. For example, return line 646 may be connected to the reservoir 648 and/or the pump 642 via an inlet 658. The return line 646 may be further coupled to the mouthpiece 602 via a return line connector 660 (e.g., an outlet of the mouthpiece 602). As such, fluid communication may be established between the pump 642 and the mouthpiece 602 via the return line 646 such that the fluid may travel in a return flow direction 662 from the mouthpiece 602 to the reservoir 648, at which point the fluid (e.g., the used fluid) may be circulated through a filter 664 contained within the reservoir 648 and/or the pump 642 to filter any unwanted contaminants from the fluid to prepare the fluid for redistribution to the mouthpiece 602 through the supply line 644. Thus, the fluid may be continuously cycled through the mouthpiece 602 without substantial loss of fluids during operation.

It should also be noted that the supply line connector 652 and/or the return line connector 660 may be structurally rigid or otherwise connected to the mouthpiece 602 to facilitate actuation of the mouthpiece 602 via the actuator 630. For example, the supply line 644 and/or the return line 646 may be routed through all or a portion of the strap 636 to connect to the pump 642 and/or the reservoir 648. The actuator 630 may be positioned adjacent to the reservoir 648 and/or the pump 642 (e.g., coupled thereto) such that actuation of the actuator 630 in the direction 634 may in turn actuate the strap 636 in the direction 638 and the direction 640, whereby the supply line connector 652 and/or the return line connector 660 may transfer such actuator into the mouthpiece 602 to thereby actuate the mouthpiece 602.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

Persons skilled in the art will understand that the various embodiments of the present disclosure and shown in the accompanying figures constitute non-limiting examples, and that additional components and features may be added to any of the embodiments discussed hereinabove without departing from the scope of the present disclosure. Additionally, persons skilled in the art will understand that the elements and features shown or described in connection with one embodiment may be combined with those of another embodiment without departing from the scope of the present disclosure to achieve any desired result and will appreciate further features and advantages of the presently disclosed subject matter based on the description provided. Variations, combinations, and/or modifications to any of the embodiments and/or features of the embodiments described herein that are within the abilities of a person having ordinary skill in the art are also within the scope of the present disclosure, as are alternative embodiments that may result from combining, integrating, and/or omitting features from any of the disclosed embodiments.

Use of the term “optionally” with respect to any element of a claim means that the element may be included or omitted, with both alternatives being within the scope of the claim. Additionally, use of broader terms such as “comprises,” “includes,” and “having” should be understood to provide support for narrower terms such as “consisting of,” “consisting essentially of,” and “comprised substantially of.” Accordingly, the scope of protection is not limited by the description set out above, but is defined by the claims that follow, and includes all equivalents of the subject matter of the claims.

In the preceding description, reference may be made to the spatial relationship between the various structures illustrated in the accompanying drawings, and to the spatial orientation of the structures. However, as will be recognized by those skilled in the art after a complete reading of this disclosure, the structures described herein may be positioned and oriented in any manner suitable for their intended purpose. Thus, the use of terms such as “above,” “below,” “upper,” “lower,” “inner,” “outer,” “left,” “right,” “upward,” “downward,” “inward,” “outward,” “horizontal,” “vertical,” etc., should be understood to describe a relative relationship between the structures and/or a spatial orientation of the structures. Those skilled in the art will also recognize that the use of such terms may be provided in the context of the illustrations provided by the corresponding figure(s).

Additionally, terms such as “approximately,” “generally,” “substantially,” and the like should be understood to allow for variations in any numerical range or concept with which they are associated and encompass variations on the order of 25% (e.g., to allow for manufacturing tolerances and/or deviations in design). For example, the term “generally parallel” should be understood as referring to configurations in with the pertinent components are oriented so as to define an angle therebetween that is equal to 180°±25% (e.g., an angle that lies within the range of (approximately) 135° to (approximately)) 225°. The term “generally parallel” should thus be understood as referring to encompass configurations in which the pertinent components are arranged in parallel relation.

Although terms such as “first,” “second,” “third,” etc., may be used herein to describe various operations, elements, components, regions, and/or sections, these operations, elements, components, regions, and/or sections should not be limited by the use of these terms in that these terms are used to distinguish one operation, element, component, region, or section from another. Thus, unless expressly stated otherwise, a first operation, element, component, region, or section could be termed a second operation, element, component, region, or section without departing from the scope of the present disclosure.

Each and every claim is incorporated as further disclosure into the specification and represents embodiments of the present disclosure. Also, the phrases “at least one of A, B, and C” and “A and/or B and/or C” should each be interpreted to include only A, only B, only C, or any combination of A, B, and C.

What is claimed is:

1. A mouthpiece toothbrush, comprising:
a carrier configured to be secured between upper teeth and lower teeth of a user;
one or more brushes movably coupled to the carrier such that the one or more brushes contact the upper teeth, the lower teeth, or both; and
an actuator configured to move the one or more brushes with respect to the carrier such that the one or more brushes move along the upper teeth, the lower teeth, or both.

2. The mouthpiece toothbrush of claim 1, wherein the one or more brushes includes:
an upper brush that is configured to contact the upper teeth; and
a lower brush that is configured to contact the lower teeth.

3. The mouthpiece toothbrush of claim 2, wherein the upper brush is configured to contact a front surface of the upper teeth and a back surface of the upper teeth, and the lower brush is configured to contact a front surface of the lower teeth and a back surface of the lower teeth.

4. The mouthpiece toothbrush of claim 2, wherein the upper brush is configured to extend around the upper teeth and the lower brush is configured to extend around the lower teeth.

5. The mouthpiece toothbrush of claim 2, wherein the carrier is positioned between the upper brush and the lower brush.

6. The mouthpiece toothbrush of claim 1, wherein the actuator is configured to move the one or more brushes laterally with respect to the upper teeth and the lower teeth such that the one or more brushes move laterally along the upper teeth, the lower teeth, or both.

7. The mouthpiece toothbrush of claim 5, wherein the actuator is configured to move the one or more brushes in an elevational direction with respect to the upper teeth and the lower teeth such that the one or more brushes move upward and downward with respect to the upper teeth, the lower teeth, or both.

8. The mouthpiece toothbrush of claim 1, further comprising:
a brush plate, wherein the one or more brushes are coupled to the brush plate and the brush plate is movably coupled to the carrier.

9. The mouthpiece toothbrush of claim 8, wherein the actuator is coupled to the brush plate.

10. The mouthpiece toothbrush of claim 8, wherein the brush plate includes an engaging portion, and the carrier includes a receiving portion that receives the engaging portion of the brush plate to movably couple the brush plate to the carrier.

11. A mouthpiece toothbrush, comprising:
a carrier configured to be secured between teeth of a user;
a brush plate movably coupled to the carrier;
one or more brushes coupled to the carrier; and
an actuator coupled to the brush plate and configured to move the brush plate with respect to the carrier such that the one or more brushes move with respect to the teeth to clean the teeth.

12. The mouthpiece toothbrush of claim 11, wherein the carrier includes a receiving portion that receives an engaging portion of the brush plate to movably couple the brush plate to the carrier.

13. The mouthpiece toothbrush of claim 12, wherein the engaging portion is flexible such that the brush plate is configured to deflect in an elevational direction with respect to the carrier.

14. The mouthpiece toothbrush of claim 11, wherein the brush plate extends substantially perpendicular to the carrier.

15. The mouthpiece toothbrush of claim 11, wherein the one or more brushes includes:
an upper brush that is configured to contact and clean upper teeth of the user; and
a lower brush that is configured to contact and clean lower teeth of the user.

16. The mouthpiece toothbrush of claim 11, wherein the brush plate and the carrier define a channel, and the teeth are configured to be positioned within the channel.

17. A mouthpiece toothbrush, comprising:
a carrier configured to be secured between upper teeth and lower teeth of a user;
a brush plate movably coupled to the carrier, wherein the brush plate and the carrier define an upper channel and a lower channel;
an upper brush coupled to the brush plate and disposed in the upper channel;
a lower brush coupled to the brush plate and disposed in the lower channel; and
an actuator coupled to the brush plate, wherein the actuator is configured to move the brush plate with respect to the carrier to move the upper brush with respect to the upper teeth and to move the lower brush with respect to the lower teeth.

18. The mouthpiece toothbrush of claim 17, wherein the upper channel is configured to receive the upper teeth and the lower channel is configured to receive the lower teeth.

19. The mouthpiece toothbrush of claim 17, wherein the brush plate and an upper surface of the carrier define the upper channel.

20. The mouthpiece toothbrush of claim 19, wherein the brush plate and a lower surface of the carrier that opposes the upper surface define the lower channel.
